(19) United States
(12) Patent Application Publication
(10) Pub. No.: US 2010/0258757 A1
(43) Pub. Date: Oct. 14, 2010

(54) VALVE FOR DISPENSING A FLUID PRODUCT AND DEVICE FOR DISPENSING A FLUID PRODUCT INCLUDING SUCH VALVE

(75) Inventors: Jacques Fontela, Vitot (FR); Gerard Van De Weghe, St. Pierre De Bosguerard (FR); Jean-Claude Luccioni, Alizay (FR); Frederic Pirou, Crasville (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS, LE NEUBOURG (FR)

(21) Appl. No.: 12/664,019

(22) PCT Filed: Jun. 5, 2008
(86) PCT No.: PCT/FR2008/051002

§ 371 Date: Jun. 1, 2010

(30) Foreign Application Priority Data
Jun. 11, 2007 (FR) 0755635

(51) Int. Cl. F16K 1/00

(52) U.S. Cl. 251/321; 251/318

(57) ABSTRACT

A fluid dispenser valve comprising a valve body (10) containing a metering chamber (20), and a valve member (30) that slides in said valve body (10) between a rest position and a dispensing position, for selectively dispensing the content of said metering chamber (20), said metering chamber (20) being, in the rest position of the valve member (30), connected to a fluid reservoir containing the fluid to be dispensed via a fluid-flow passage (35, 35′), said valve member (30) including a radial support collar, said fluid-flow passage (35, 35′) passing, level with said collar (320), inside said valve member (30) and/or said collar (320), at least in part, so as to enable the metering chamber (20) to be filled by gravity when, in the rest position of the valve member (30), the valve is in an upsidedown position with the metering chamber (20) disposed below the reservoir, and so as to enable said metering chamber (20) to be emptied by gravity when, in the rest position of the valve member (30), the valve is in an upright position with the metering chamber (20) disposed above the reservoir.

The present invention relates to a fluid dispenser valve.

More particularly, the present invention relates to a “metering” valve in which an accurate dose of fluid is dispensed each time the valve is actuated. Such valves are well known in the prior-art and are generally assembled on a reservoir containing the fluid and a propellant gas used to expel the dose. In particular, two types of metering valve are known, namely: firstly those that, after filling the metering chamber, close said metering chamber in leaktight manner until the next time the valve is actuated; and secondly those that are filled only just before actuation proper. In the first category, a problem can occur of an incomplete dose and/or of non-uniformity of the dose when it is expelled, in particular if the valve has been stored for some time, resulting in the active fluid no longer being distributed in completely uniform manner in the metering chamber. To avoid that problem, the valves of the second category enable the metering chamber to be filled quickly when the user actuates the valve. With that type of valve, after each actuation, the metering chamber can fill up once again, but if the valve is then stored in its upright position, the metering chamber can thus empty into the reservoir, the metering chamber thus not being closed in leaktight manner. Document FR-2 860 503 describes a prior-art valve.

An object of the present invention is to improve metering valves of the second category, i.e. metering valves in which the metering chamber is not closed in leaktight manner while the valve member is in its rest position.

In particular, an object of the present invention is to provide a fluid dispenser valve that is simple and inexpensive to manufacture and to assemble, and that is reliable in operation.

Another object of the present invention is to provide a fluid dispenser valve that makes it possible to fill the metering chamber in easy and safe manner before each actuation, while guaranteeing good reliability in operation of said valve.

The present invention thus provides a fluid dispenser valve comprising a valve body containing a metering chamber, and a valve member that slides in said valve body between a rest position and a dispensing position, for selectively dispensing the content of said metering chamber, said metering chamber being, in the rest position of the valve member, connected to a fluid reservoir containing the fluid to be dispensed via a fluid-flow passage, said valve member including a radial support collar, said fluid-flow passage passing, level with said collar, inside said valve member and/or said collar, at least in part, so as to enable the metering chamber to be filled by gravity when, in the rest position of the valve member, the valve is in an upsidedown position with the metering chamber disposed below the reservoir, and so as to enable said metering chamber to be emptied by gravity when, in the rest position of the valve member, the valve is in an upright position with the metering chamber disposed above the reservoir.

Advantageously, said valve member is urged resiliently towards its rest position by a spring that co-operates firstly with the valve body, and secondly with said radial support collar of the valve member.

In a first embodiment of the invention, said radial collar includes at least one axial through passage for the flow of fluid.

Advantageously, said radial collar includes a peripheral wall that is preferably substantially annular, and at least one, advantageously at least two, preferably at least three axial through passages defined radially inside said peripheral wall.

Advantageously, said radial collar is formed in a valve-member bottom portion that is assembled in a valve-member top portion.

Advantageously, said collar is formed on a tubular piece that is assembled, in particular engaged, around said valve member.

In a second embodiment, said flow passage extends inside said valve member, at least in part.

Advantageously, said valve member includes a central internal axial passage that extends inside said valve member over a fraction of its height, said axial passage being open at the bottom end of the valve member and at an intermediate portion of said valve member.

Advantageously, said axial passage is open at the bottom axial end of the valve member, in the upright position of the valve, and laterally at the intermediate portion of the valve member.

Advantageously, said valve member is made out of two portions assembled together one inside the other, preferably at said intermediate portion.

Advantageously, said flow passage passes exclusively inside said valve member.

Advantageously, said flow passage passes inside and outside said valve member.

The present invention also provides a fluid dispenser device including a valve as described above.

These characteristics and advantages and others of the present invention appear more clearly from the following detailed description of three embodiments thereof, given by way of non-limiting example, and with reference to the accompanying drawings, in which:

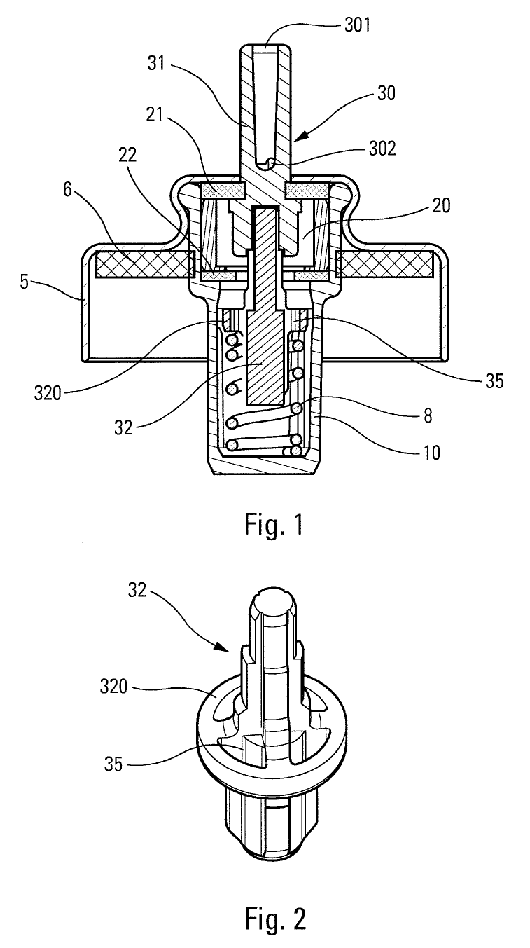

FIG. 1 is a diagrammatic section view of a dispenser valve constituting a first embodiment of the present invention, in the rest position;

FIG. 2 is a perspective view of a detail of the bottom portion of the valve member of the valve in FIG. 1.

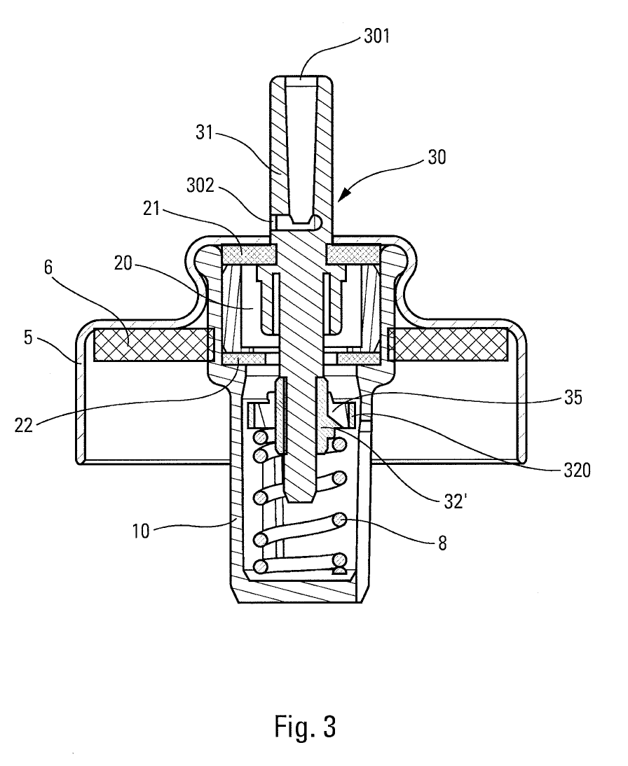

FIG. 3 is a view similar to the view in FIG. 1, showing a second embodiment of the present invention; and

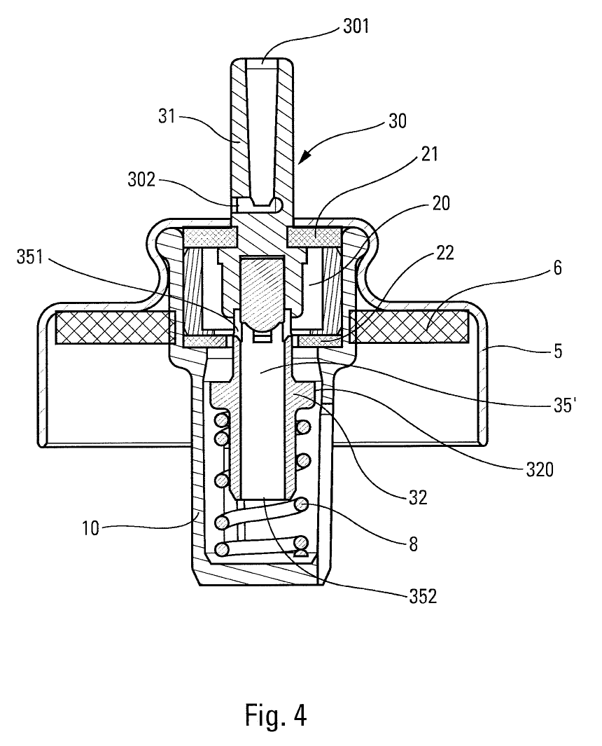

FIG. 4 is a view similar to the views in FIGS. 1 and 3, showing a third embodiment of the present invention.

The valve shown in FIG. 1 comprises a valve body 10 inside which a valve member 30 slides between a rest position, that is the position shown in the figure, and a dispensing position in which the valve member 30 is pressed down into the valve body 10. The valve is generally for assembling on a reservoir (not shown), preferably by means of a fastener element 5 that can be a crimpable, screw-fastenable, or snap-fastenable cap, and that advantageously has a neck gasket 6 interposed therebetween. A ring (not shown) may be assembled around the valve body, in particular so as to decrease the dead volume in the upsidedown position, and so as to limit contact between the fluid and the neck gasket. The valve member 30 is urged towards its rest position by a spring 8 that is disposed in the valve body 10 and that co-operates firstly with the valve body 10, and secondly with a radial support collar 320 of the valve member 30. A metering chamber 20 is defined inside the valve body 10, said valve member 30 sliding inside said metering chamber so as to make it possible to dispense the content thereof while the valve is being actuated. In well known manner, the metering chamber is preferably defined between two annular gaskets, a valve-member gasket 21 and a chamber gasket 22. FIG. 1 shows the valve in the rest position of the valve member and in the upright position, i.e. the position in which the metering chamber 20 is disposed above the reservoir (not shown). The valve member 30 includes an outlet orifice 301 that is connected to an inlet orifice 302 that is disposed in the metering chamber 20 when the valve member 30 is in its dispensing position.

In order to improve guidance of the valve member 30 and thus guarantee reliable operation of the valve, the outer peripheral surface of the collar 320 is preferably of shape that corresponds approximately to the shape of the valve body 10, i.e. generally cylindrical, and is advantageously disposed a small distance away from said valve body, so as to avoid any risk of said valve member being offset axially while it is being actuated.

As shown in FIG. 1, when the valve member 30 is in its rest position, the metering chamber 20 is permanently connected to the reservoir, since the metering chamber 20 is not closed in leaktight manner in the rest position of the valve member 30. When the valve is stored in its upright position, the metering chamber thus empties, and when the user wishes to use the valve, the user must turn it into its upsidedown position, i.e. the position in which the metering chamber 20 is disposed below the reservoir, so that said metering chamber can be filled by gravity.

In the invention, to promote rapid and reliable filling of the metering chamber, the fluid-flow passage between the metering chamber 20 and the reservoir passes, level with the collar 320, inside the valve member 30, at least in part. More precisely, as a result of the small offset between the outer periphery of the collar 320 and the valve body 10, a flow passing exclusively into the valve member might be hindered or at least slowed down, and that can pose metering problems when the user actuates the valve relatively quickly, after positioning it in its upsidedown position. The provision of a fluid-flow passage 35 inside the valve member 30, at least in part, makes it possible to guarantee a more rapid flow and thus a more reliable filling of the metering chamber 20. As shown more precisely in FIG. 2, the radial collar may comprise a peripheral wall 320 that is preferably substantially annular or cylindrical, together with at least one axial through passage, advantageously at least two, preferably at least three passages. The embodiment shown in FIG. 2 even includes four through passages 35. The passages 35 are defined radially inside the peripheral wall 320, and around a central core of the valve member.

In the embodiment in FIGS. 1 and 2, the valve member 30 is made out of two portions, namely a top portion 31 (also known as a valve-member top) and a bottom portion 32 (also known as a valve-member bottom) when observed in the upright position in FIG. 1. In this embodiment, the bottom portion 32 is assembled inside the top portion 31, and the collar 320 forms an integral part of the bottom portion 32, as is clearly visible in FIG. 2.

FIG. 3 shows a second variant embodiment of the present invention, in which the collar 320 forms part of a tubular piece 32′ that is assembled, preferably engaged, around the valve member 30. In this embodiment, the valve member 30 is made substantially as a single piece, and it is the tubular piece 32′ that defines both the collar 320 providing effective guidance for the valve member while it is being actuated, and the fluid-flow through hole(s) 35 as described with reference to the first embodiment shown in FIGS. 1 and 2. This embodiment provides better rigidity as a result of there being no need to assemble together a bottom portion and a top portion of the valve member. As shown diagrammatically in FIG. 3, the inside of the through hole(s) 35 may include sloping or helical profiles so as to impart a slightly swirling movement to the fluid when it passes through the passages, and that tends to make the dose thoroughly uniform on entering into the metering chamber 20. This configuration could also be provided in the embodiment in the FIGS. 1 and 2.

FIG. 4 shows another embodiment of the present invention, in which the flow passage 35′ extends, level with the collar 320, inside the valve member 30, at least in part, in particular in axial and central manner. In the embodiment in FIG. 4, once again the valve member is constituted by two portions, a top portion 31 and a bottom portion 32, the bottom portion 32 being assembled inside the top portion 31. Advantageously, the internal axial passage 35′ extends inside the bottom portion 32 over a major fraction of its height, advantageously from the open bottom axial end 352 to a side opening 351 disposed above the collar 320, advantageously in the proximity of the interface between the bottom portion and the top portion. The side opening 351 opens into the metering chamber 20, at least in part, so as to enable it to be filled. The flow passage 35′ thus extends between the bottom end of the valve member and an intermediate portion thereof. The embodiment shown in FIG. 4 implies two flows both while the metering chamber 20 is being filled and while it is being emptied: a first fraction of the flow (generally the main fraction) passing inside the valve member 30 via the axial flow passage 35′; and another fraction of the flow passing outside the valve member 30 and outside the collar 320. The two flows also make it possible to obtain a uniform dose inside the metering chamber when dispensing therefrom. In a variant, and in any position, the outside of the valve member 30 may co-operate in leaktight manner with the gasket 22 of the metering chamber 20, so that the flow passage 35′ between the metering chamber and the reservoir passes exclusively inside the valve member 30. In a variant, the collar 320, that is solid in the embodiment in FIG. 4, could also include one or more through passages or slots for the fluid. The passages or slots could also be provided in the valve-member portion disposed between the collar 320 and the gasket 22. That would make it possible to limit the dead volume, in particular in a configuration similar to the configuration in FIG. 4, but in which the gasket 22 co-operates in leaktight manner with the outside of the valve member, thereby promoting filling in the upsidedown position.

Although the present invention is described above with reference to several embodiments thereof, naturally it is not limited by the embodiments shown. On the contrary, any useful modification could be applied thereto by a person skilled in the art, without going beyond the ambit of the present invention, as defined by the accompanying claims.

1-13. (canceled)

14. A fluid dispenser valve comprising a valve body (10) containing a metering chamber (20), and a valve member (30) that slides in said valve body (10) between a rest position and a dispensing position, for selectively dispensing the content of said metering chamber (20), said metering chamber (20) being, in the rest position of the valve member (30), connected to a fluid reservoir containing the fluid to be dispensed via a fluid-flow passage (35, 35′), said valve member (30) including a radial support collar, the valve being characterized in that said fluid-flow passage (35, 35′) passes, level with said collar (320), partially inside said valve member (30) and partially outside said collar (320), so as to enable the metering chamber (20) to be filled by gravity when, in the rest position of the valve member (30), the valve is in an upsidedown position with the metering chamber (20) disposed below the reservoir, and so as to enable said metering chamber (20) to be emptied by gravity when, in the rest position of the valve member (30), the valve is in an upright position with the metering chamber (20) disposed above the reservoir.

15. A valve according to claim 14, wherein said valve member (30) is urged resiliently towards its rest position by a spring (8) that co-operates firstly with the valve body (10), and secondly with said radial support collar (320) of the valve member (30).

16. A valve according to claim 14, wherein said radial collar (320) includes at least one axial through passage (35) for the flow of fluid.

17. A valve according to claim 16, wherein said radial collar includes a peripheral wall (320) that is preferably substantially annular, and at least one, advantageously at least two, preferably at least three axial through passages (35) defined radially inside said peripheral wall.

18. A valve according to claim 14, wherein said radial collar (320) is formed in a valve-member bottom portion (32) that is assembled in a valve-member top portion (31).

19. A valve according to claim 14, wherein said collar (320) is formed on a tubular piece (32′) that is assembled, in particular engaged, around said valve member (30).

20. A valve according to claim 14, wherein said valve member (30) includes a central internal axial passage (35′) that extends inside said valve member (30) over a fraction of its height, said axial passage (35′) being open at the bottom end (352) of the valve member (30) and at an intermediate portion (351) of said valve member.

21. A valve according to claim 20, wherein said axial passage (35′) is open at the bottom axial end (352) of the valve member (30), in the upright position of the valve, and laterally at the intermediate portion (351) of the valve member.

22. A valve according to claim 14, wherein said valve member (30) is made out of two portions (31, 32) assembled together one inside the other, preferably at said intermediate portion.

23. A fluid dispenser device characterized in that it includes a valve according to claim 14.
